(19) United States
(12) Patent Application Publication
(10) Pub. No.: US 2002/0055371 A1
(43) Pub. Date: May 9, 2002

(54) Cellular base station with remote antenna

(76) Inventors: Shlomi Arnon, Be'er Sheva (IL); Nissim Attias, Raanana (IL); Paul Goldgeiger, Haifa (IL); Yirmi Hauptman, Rishon Lezion (IL); Ronen Keshet, Tel Aviv (IL); Pini Sabach, Jerusalem (IL); Yoni Shiff, Rishon Lezion (IL)

Correspondence Address: Woodcock Washburn Kurtz, Mackiewicz & Norris LLP, One Liberty Place - 46th Floor, Philadelphia, PA, 19103, US

(21) Appl. No.: 09/863,162

(22) Filed: May 23, 2001

Related U.S. Application Data
(60) Provisional application No. 60/247,060, filed on Nov. 10, 2000.
(60) Provisional application No. 60/247,395, filed on Nov. 9, 2000.
(60) Provisional application No. 60/253,365, filed on Nov. 27, 2000.
(60) Provisional application No. 60/259,813, filed on Jan. 3, 2001.
(60) Provisional application No. 60/259,812, filed on Jan. 3, 2001.
(60) Provisional application No. 60/259,815, filed on Jan. 3, 2001.
(60) Provisional application No. 60/259,829, filed on Jan. 4, 2001.
(60) Provisional application No. 60/281,233, filed on Apr. 2, 2001.

(51) Int. Cl. H04M 1/00

(52) U.S. Cl. 455/562; 455/561; 455/11.1

(57) ABSTRACT

Apparatus for transferring information within a cellular network, including a base-station transceiver system (BTS) positioned at a first location, and an antenna assembly, positioned at a second location remote from the first location. The BTS includes communication control circuitry which generates down-link radio-frequency (RF) signals and processes up-link RF signals, and first transducer circuitry which modulates a first beam of unguided electromagnetic radiation with the downlink RF signals and demodulates a second beam received from the antenna assembly to recover the up-link signals.

The antenna assembly includes second transducer circuitry which modulates the second beam with the up-link signals, and radiates the modulated beam to the BTS. The second transducer circuitry also demodulates the first beam to recover the down-link signals, and transfers the signals to an antenna, included in the assembly, which radiates the down-link signals.

### CROSS-REFERENCE TO RELATED APPLICATIONS

This application claims the benefit of U.S. Provisional Applications No. 60/247,060 filed Nov. 10, 2000, No. 60/247,395 filed Nov. 9, 2000, No. 60/253,365 filed Nov. 27, 2000, No. 60/259,812 filed Jan. 3, 2001, No. 60/259,813 filed Jan. 3, 2001, No. 60/259,815 filed Jan. 3, 2001, No. 60/259,829 filed Jan. 4, 2001, and No. 60/281,233 filed Apr. 2, 2001, which are assigned to the assignee of the present patent application and are incorporated herein by reference.

### FIELD OF THE INVENTION

The present invention relates generally to cellular networks, and specifically to the formation of cells within a cellular network

### BACKGROUND OF THE INVENTION

A cellular network covering a region is formed by dividing the region into a number of cells, some of which partially overlap, and some of which do not overlap. Having partially overlapping cells enables a mobile transceiver moving between these cells to communicate without interruption. Having some non-overlapping cells enables these cells to use substantially the same frequency bandwidth without interference. Thus, by providing non-overlapping cells, the network is able to increase the number of users of the network without a corresponding increase in frequency bandwidth.

Theoretically, a given region having a given number of mobiles within the region may be covered by a few large cells, the cells using one relatively large bandwidth. Alternatively, the same region with the same number of mobiles may be covered by a larger number of smaller cells, more of which are substantially non-overlapping overlapping compared to the large cell system, so that the cells may use a smaller bandwidth. In cases where bandwidth is a limiting factor, the larger number of smaller cells option becomes more attractive.

A cell within a region is substantially equivalent to an area within that region wherein mobile transceivers are able to communicate with one or more antennas which transmit and receive on a specific frequency bandwidth. Thus the one or more antennas, and their ability to receive/transmit signals between mobiles operative within the network, substantially define the cell.

FIG. 1 is a schematic diagram showing operation of a cellular network 10, as is known in the art. Network 10 comprises three base-station transceiver systems (BTSs), which are each substantially collocated with respective antenna systems, forming BTS-antenna systems 12, 14, and 16. Systems 12, 14, and 16 are controlled by a base-station controller (BSC) 18, which in turn communicates with a switching center 20 external to network 10. Each system 12, 14, and 16 communicates with mobile transceivers, such as a mobile 22, within a respective cell 12A, 14A, and 16A.

Methods for subdividing an existing cell of a cellular network using optical links for transferring information and/or data are known in the art. Typical systems use a fiber optic or light guide to convey optical radiation, although other systems transfer optical radiation via substantially free space, e.g., through the atmosphere of the Earth. Some of the advantages of using optical radiation, as distinct from microwave or lower frequency radiation, are that the optical radiation has an inherently high carrying capacity due to its frequency being of the order of 100 THz. Other reasons for using optical radiation as a carrier are the availability of coherent optical sources which can be switched at speeds of the order of 100 GHz, and the fact that at least some of these coherent sources are implemented as monolithic solid-state devices.

U.S. Pat. No. 6,049,593 to Acampora, whose disclosure is incorporated herein by reference, describes a cellular system wherein picocells, interconnected by short optical links of the order of 100 m length, comprise a larger cell of a communications network.

U.S. Pat. No. 5,844,705 to Rutledge, whose disclosure is incorporated herein by reference, describes a method for subdividing a cell of a cellular system into sub-cells. A central transceiver-antenna system is separated into a plurality of remote antennas. At the position of each of the remote antennas there is associated circuitry for controlling transmissions between the respective antenna and mobile transceivers within range of the antenna, i.e. in the sub-cell defined by the antenna. Each set of circuitry also communicates with a corresponding transceiver located at a center of the cell via unguided optical radiation. The corresponding transceivers communicate with a communications system infrastructure located outside the cell.

U.S. Pat. No. 5,493,436 to Karasawa et al., whose disclosure is incorporated herein by reference, describes a method for communicating between a mobile transceiver and an exchange station. Transmissions from the mobile transceiver are received by an antenna remote from the exchange station. The transmissions are converted to optical radiation which is conveyed, at least partly via optical guides, to the exchange station. A similar procedure is followed for transmissions from the exchange station to the mobile.

### SUMMARY OF THE INVENTION

It is an object of some aspects of the present invention to provide a method and apparatus for communicating between a base-station transceiver system (BTS) and an antenna remote from the BTS.

In preferred embodiments of the present invention, a base-station transceiver system (BTS) comprises communication control circuitry. The circuitry generates down-link RF signals which are receivable by a mobile cellular transceiver operative within a cellular network. The BTS also comprises BTS-transducer-circuitry which modulates a first beam of unguided electromagnetic radiation with the down-link RF signals and radiates the modulated beam. The modulated beam is received by an antenna assembly which is positioned remote from the BTS. The assembly comprises antenna-transducer-circuitry which receives the modulated beam and recovers the down-link RF signals from the beam. The recovered down-link signals are transmitted to the mobile by an antenna comprised in the antenna assembly.

The antenna also receives up-link RF signals from the mobile. The antenna-transducer-circuitry modulates a second beam of unguided electromagnetic radiation with the up-link signals, and the circuitry radiates the modulated second beam back to the BTS. The BTS-transducer-circuitry receives and demodulates the second beam so as to recover the up-link RF signals, which are conveyed to the communication control circuitry of the BTS. The communication control circuitry then processes the recovered up-link signals. Unlike systems known in the art, wherein communication control circuitry comprised in a BTS is coupled by a cable to an antenna, communication control circuitry in preferred embodiments of the present invention is coupled via unguided electromagnetic radiation with an associated antenna remote from the communication control circuitry. Coupling the antenna to the control circuitry of the BTS in this manner significantly increases choices of possible antenna positions. Thus, for a given BTS position the number and coverage areas of cells are increased.

In preferred embodiments of the present invention, the electromagnetic radiation comprising the first and/or the second beam is modulated by analog modulation, or digital modulation, or a combination of analog with digital modulation.

In some preferred embodiments the first and/or second beam electromagnetic radiation is generated by a light emitting diode (LED) or other incoherent radiation source. In other preferred embodiments the electromagnetic radiation is generated by a source, such as a laser, emitting substantially coherent radiation.

There is therefore provided, according to a preferred embodiment of the present invention, apparatus for transferring information within a cellular network, including:

a base-station transceiver system (BTS) positioned at a first location, which includes:

communication control circuitry, adapted to generate down-link radio-frequency (RF) signals receivable by a mobile cellular transceiver operative within the cellular network and to process up-link RF signals transmitted by the mobile cellular transceiver; and

first transducer circuitry, adapted to modulate a first beam of unguided electromagnetic radiation with the down-link RF signals and to radiate the modulated beam as a first modulated beam, and to receive and demodulate a second modulated beam of unguided electromagnetic radiation so as to recover the up-link RF signals; and

an antenna assembly, positioned at a second location remote from the first location, which includes:

second transducer circuitry, adapted to modulate a second beam of unguided electromagnetic radiation with the up-link RF signals and to radiate the modulated beam as the second modulated beam to the BTS, and to receive and demodulate the first modulated beam of unguided electromagnetic radiation from the BTS so as to recover the down-link RF signals; and

an antenna, adapted to radiate the recovered downlink RF signals to the mobile cellular transceiver and to receive the up-link RF signals from the mobile cellular transceiver.

Preferably, the first and the second transducer circuitry are adapted to radiate the first modulated beam and the second modulated beam via a path between the BTS and the antenna comprising free space.

Further preferably, at least one of the first and second transducer circuitry includes a laser which transmits coherent radiation as the unguided electromagnetic radiation between the BTS and the antenna.

Preferably, at least one of the first and second transducer circuitry includes at least one emitter which transmits incoherent radiation as the unguided electromagnetic radiation between the BTS and the antenna.

Preferably, the first location is separated from the second location by a distance chosen from a range between approximately 10 m and approximately 700 m.

Preferably, at least one of the first and second beams includes electromagnetic radiation having a wavelength chosen from a range between approximately 0.3 μm and approximately 30 μm.

Alternatively, at least one of the first and second beams includes electromagnetic radiation having a wavelength chosen from a range between approximately 1 mm and approximately 30 cm.

Preferably, the apparatus includes a switching center which is adapted to generate the information responsive to the up-link and down-link signals and to transfer the information between the BTS and at least one communication system chosen from a group comprising a public switched telephone network (PSTN), a distributed packet transfer network, a satellite communications system, and a second cellular network.

Further preferably, the apparatus includes a base-station controller (BSC) which controls the BTS.

Preferably, at least one of the down-link RF signals and the up-link RF signals include a plurality of separate RF signals.

Preferably, the first transducer circuitry includes an analog-to-digital converter which is adapted to digitize the down-link RF signals so as to generate down-link digitized signals, and the second transducer circuitry inlcudes a digital-to-analog converter which is adapted to recover the down-link RF signals from the down-link digitized signals.

Further preferably, the first transducer circuitry is adapted to compress the down-link digitized signals so as to generate compressed down-link digital signals, and the second transducer circuitry is adapted to decompress the compressed down-link digital signals so as to recover the down-link digitized signals.

Preferably, the second transducer circuitry includes an analog-to-digital converter which is adapted to digitize the up-link RF signals so as to generate up-link digitized signals, and the first transducer circuitry includes a digital-to-analog converter which is adapted to recover the up-link RF signals from the up-link digitized signals.

Further preferably, the second transducer circuitry is adapted to compress the up-link digitized signals so as to generate compressed up-link digital signals, and the second transducer circuitry is adapted to decompress the compressed up-link digital signals so as to recover the up-link digitized signals.

There is further provided, according to a preferred embodiment of the present invention, a method for transferring information within a cellular network, including:

positioning a base-station transceiver system (BTS) at a first location;

generating in communication control circuitry included in the BTS down-link radio-frequency (RF) signals receivable by a mobile cellular transceiver operative within the cellular network;

modulating a first beam of unguided electromagnetic radiation with the down-link RF signals in first transducer circuitry included in the BTS, so as to form a first modulated beam;

radiating the first modulated beam from the first transducer circuitry;

receiving and demodulating a second modulated beam of unguided electromagnetic radiation in the first transducer circuitry so as to recover up-link RF signals transmitted by the mobile cellular transceiver;

processing the up-link RF signals in the communication control circuitry;

positioning an antenna assembly at a second location remote from the first location;

receiving in an antenna included in the antenna assembly the up-link signals from the mobile cellular transceiver;

modulating a second beam of unguided electromagnetic radiation with the up-link RF signals in second transducer circuitry included in the antenna assembly, so as to form the second modulated beam ;

radiating the second modulated beam from the second transducer circuitry to the BTS;

receiving and demodulating in the second transducer circuitry the first modulated beam from the first transducer circuitry so as to recover the down-link RF signals; and

radiating the recovered down-link RF signals from the antenna to the mobile cellular transceiver.

Preferably, radiating the first modulated beam and radiating the second modulated beam includes radiating the beams via a path between the BTS and the antenna including free space.

Preferably, the method includes providing at least one laser which transmits coherent radiation as the unguided electromagnetic radiation between the BTS and the antenna.

Alternatively, the method includes providing at least one emitter which transmits incoherent radiation as the unguided electromagnetic radiation between the BTS and the antenna.

Preferably, the first location is separated from the second location by a distance chosen from a range between approximately 10 m and approximately 700 m.

Further preferably, at least one of the first and second beams includes electromagnetic radiation having a wavelength chosen from a range between approximately 0.3 μm and approximately 30 μm.

Alternatively, at least one of the first and second beams includes electromagnetic radiation having a wavelength chosen from a range between approximately 1 mm and approximately 30 cm.

Preferably, the method includes generating the information responsive to the up-link and down-link signals and transferring the information between the BTS and at least one communication system chosen from a group comprising a public switched telephone network (PSTN), a distributed packet transfer network, a satellite communications system, and a second cellular network.

Further preferably, the method includes controlling the BTS with a base-station controller (BSC).

Preferably, at least one of the down-link RF signals and the up-link RF signals comprise a plurality of separate RF signals.

Preferably, the method includes:

digitizing the down-link RF signals in an analog-to-digital converter included in the first transducer circuitry so as to generate down-link digitized signals, and

recovering the down-link RF signals from the downlink digitized signals in a digital-to-analog converter included in the second transducer circuitry.

Further preferably, the method includes:

compressing the down-link digitized signals in the first transducer circuitry so as to generate compressed down-link digital signals; and

decompressing the compressed down-link digital signals in the second transducer circuitry so as to recover the down-link digitized signals.

Preferably, the method includes:

digitizing the up-link RF signals in an analog-to-digital converter included in the second transducer circuitry so as to generate up-link digitized signals, and

recovering the up-link RF signals from the up-link digitized signals in a digital-to-analog converter included in the first transducer circuitry.

Further preferably, the method includes:

compressing the up-link digitized signals in the second transducer circuitry so as to generate compressed up-link digital signals; and

decompressing the compressed up-link digital signals in the first transducer circuitry so as to recover the up-link digitized signals.

The present invention will be more fully understood from the following detailed description of the preferred embodiments thereof, taken together with the drawings, in which:

### BRIEF DESCRIPTION OF THE DRAWINGS

FIG. 1 is a schematic diagram showing operation of a cellular network, as is known in the art;

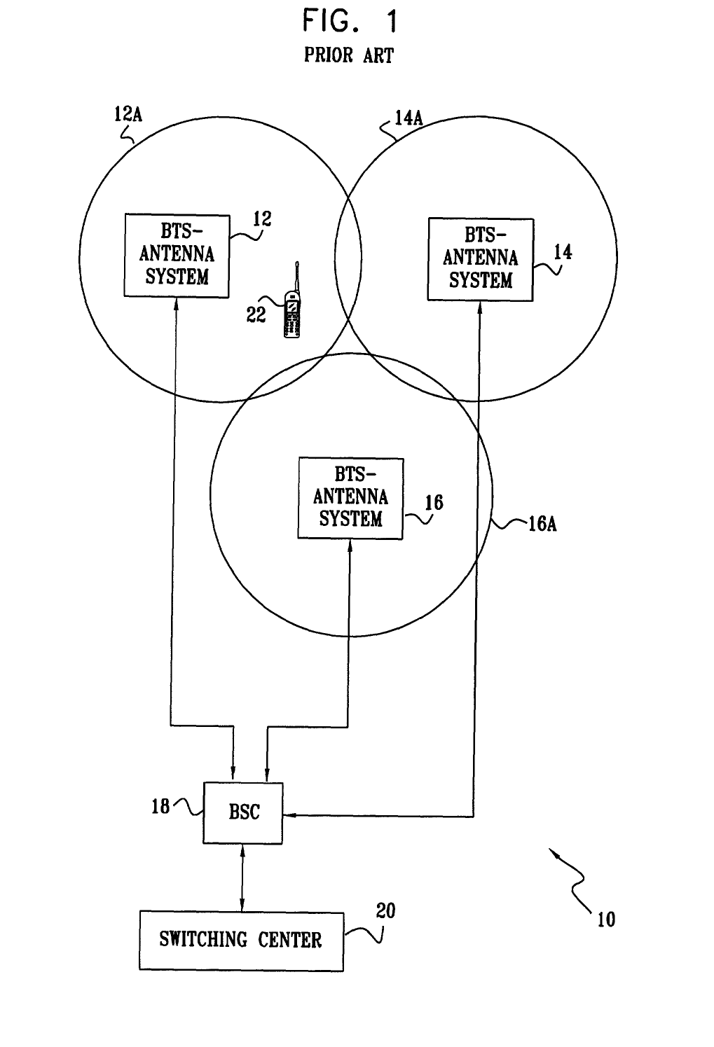

FIG. 2 is a schematic diagram illustrating connections between elements of a cellular network, according to a preferred embodiment of the present invention;

FIG. 3 is a schematic diagram showing details of a base-station transceiver system and an antenna assembly comprised in the network of FIG. 2, according to a preferred embodiment of the present invention; and

FIG. 4 is a schematic diagram showing details of a radiation link between the base-station transceiver system and the antenna assembly of FIG. 3, according to a preferred embodiment of the present invention.

### DETAILED DESCRIPTION OF PREFERRED EMBODIMENTS

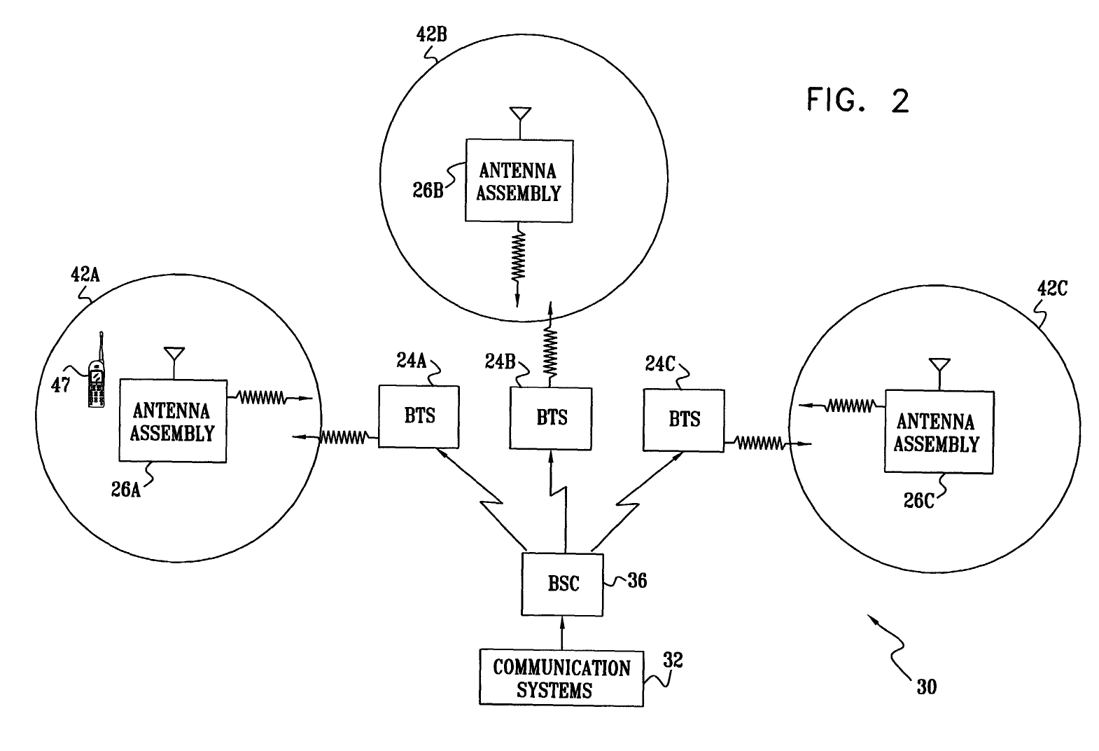

Reference is now made to FIG. 2, which is a schematic diagram illustrating connections between elements of a cellular network 30, according to a preferred embodiment of the present invention. Network 30 comprises a base-station controller (BSC) 36, and preferably operates according to an industry-standard cellular protocol. BSC 36 controls a plurality of substantially similar base-station transceiver systems (BTSs) 24A, 24B, 24C. Each BTS 24A, 24B, 24C communicates with a respective antenna assembly 26A, 26B, and 26C. Each BTS and its respective antenna assembly are separated from each other, most preferably by a distance between approximately 10 m and 700 m, although the principles of the present invention apply to BTSs and antenna assemblies separated by other distances.

Network 30 most preferably operates according to one or more industry-standard multiplexing systems, such as a time division multiple access (TDMA) or code division multiple access (CDMA) system, and preferably operates in a radio-frequency (RF) band which is allocated for cellular communications. Network 30 is implemented so as to enable mobile transceivers within regions 42A, 42B, and 42C, covered by respective antenna assemblies 26A, 26B, and 26C, to communicate with each other, via RF signals between the assemblies and the mobile transceivers.

In addition to controlling BTSs 24A, 24B, and 24C, BSC 36 most preferably communicates with communication systems 32 external to network 30, such systems comprising at least some of a group consisting of a hard-wired telephone network such as a public switched telephone network (PSTN), a distributed packet transfer network such as the Internet, a satellite communications system, and one or more cellular networks not comprised in network 30.

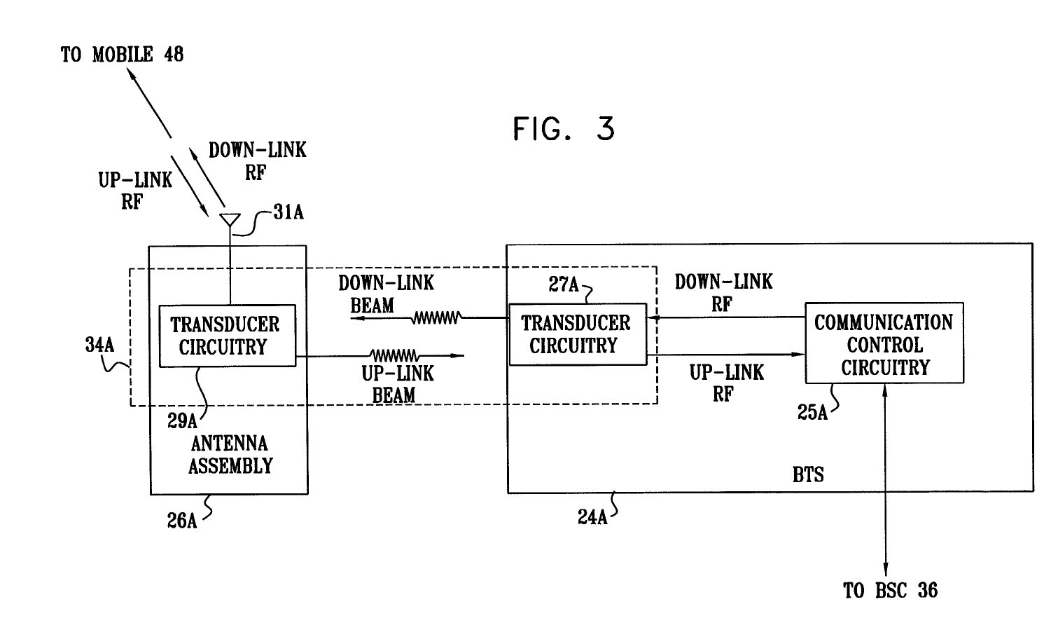

FIG. 3 is a schematic diagram showing details of BTS 24A and antenna assembly 26A, according to a preferred embodiment of the present invention. While the following description is directed to BTS 24A and its antenna assembly 26A, it will be appreciated that the description applies, mutatis mutandis, to the other BTSs and their respective antenna assemblies in network 30. BTS 24A comprises communication control circuitry (BTS-CCC) 25A which generates down-link radio-frequency (RF) signals that are receivable by mobile transceivers, such as a mobile transceiver 47 (FIG. 2), operative in network 30. The circuitry is also able to receive and process up-link RF signals transmitted from the mobile transceivers. Preferably BTS-CCC 25A generates down-link signals in a frequency band of 869-894 MHz and is able to receive and process up-link signals in a frequency band of 824-849 MHz. However, it will be appreciated that the scope of the present invention applies to up-link and down-link signals transmitted in other frequency bands. BTS-CCC 25A communicates with BSC 36 in substantially the same manner as a BTS communicates with a BSC in systems known in the art.

BTS 24A comprises BTS-transducer-circuitry (BTS-TC) 27A, which receives down-link RF signals from communication control circuitry 25A and which transmits up-link RF signals to the control circuitry. BTS-TC 27A generates a down-link radiation beam, and modulates the beam with the down-link RF signals. BTS-TC 27A then radiates the modulated down-link beam to an antenna assembly 26A. Assembly 26A comprises antenna-assembly-transducer-circuitry (AA-TC) 29A which receives the modulated beam, and which recovers the down-link RF signals. AA-TC 29A transfers the down-link signals to an antenna 31A comprised in the assembly, which radiates the signals to mobile transceiver 47 within range of the antenna.

Mobile 47 radiates up-link RF signals to antenna 31A, and the antenna transfers the signals to AA-TC 29A. Circuitry 29A generates an up-link radiation beam, modulates the beam with the up-link RF signals, and then radiates the modulated up-link beam to BTS-TC 27A. The BTS-transducer-circuitry receives and demodulates the up-link beam so as to recover the up-link RF signals, which BTS-TC 27A transfers to BTS-CCC 25A. BTS-CCC 25A then processes the recovered up-link RF signals by methods known in the cellular communication art.

It will be appreciated that BTS-TC 27A and AA-TC 29A form a full duplex radiation link 34A coupling control circuitry 25A to antenna 31A, unlike other systems known in the art coupling communication control circuitry of a BTS to its antenna. It will be further appreciated that coupling communication control circuitry of a BTS to its antenna using a radiation link significantly increases the flexibility of positioning the antenna, compared to systems known in the art.

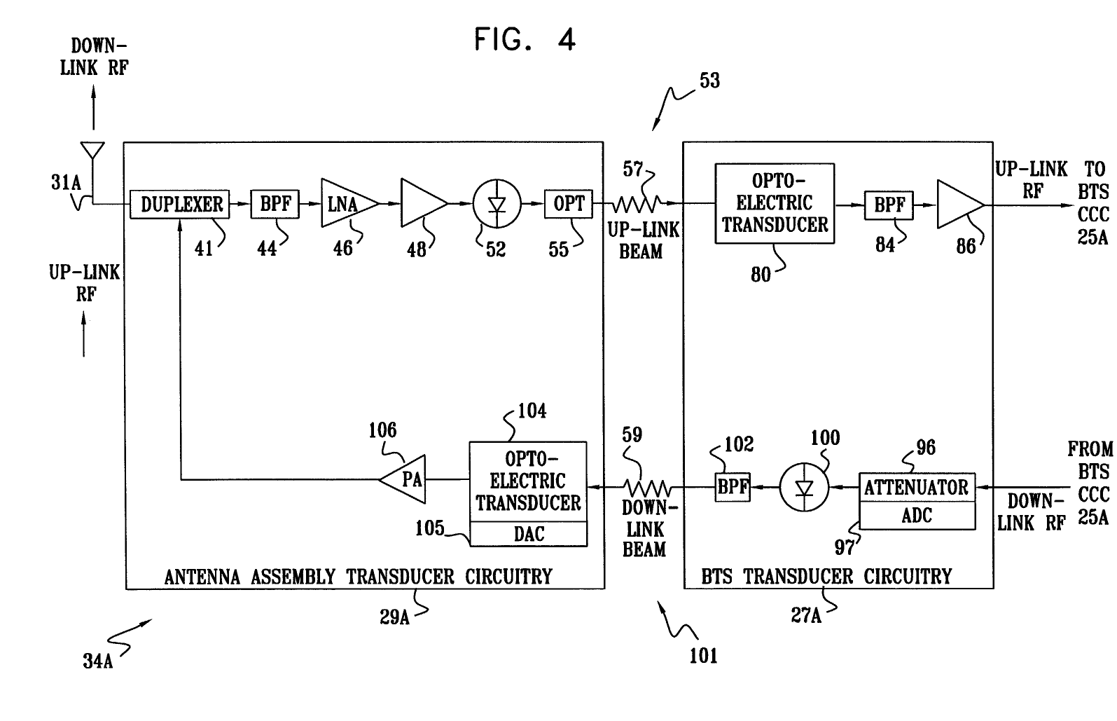

FIG. 4 is a schematic diagram showing details of radiation link 34A, according to a preferred embodiment of the present invention. In an up-link path 53, mobile transceiver 47 transmits an up-link RF signal to antenna 31A, which transfers the signal to a duplexer 41 comprised in AA-TC 29A. Duplexer 41 acts to convey the up-link RF signal from antenna 31A, and also to convey a down-link RF signal, described in more detail below, to the antenna. The up-link signal is passed to a band-pass filter (BPF) 44, which most preferably transmits in a bandwidth for conveying up-link signals defined by a protocol under which network 30 operates, such as 824-849 MHz, and rejects signals at other frequencies. The filtered signal from BPF 44 is amplified by a low noise amplifier (LNA) 46, and a second amplifier 48, which preferably provide a total gain of the order of 70 dB. The amplified up-link signal is input as a modulating signal to a light emitter 52. Most preferably, amplifiers 46 and 48 set a level of the output from amplifier 48 to provide a suitable modulation depth for an emitter 52. Most preferably, emitter 52 comprises a solid state laser diode. Alternatively, emitter 52 is any other suitable electromagnetic wave emitter, known in the art, that emits waves which may be modulated and detected. The modulation is implemented as any type of analog or digital modulation, or combination thereof, known in the art.

Emitter 52 most preferably generates coherent radiation having a wavelength of the order 1,550 nm at a power of the order of 50 mW, or alternatively at any other convenient power. The radiation is collimated to a substantially parallel beam by collimating optics 55. For example, if emitter 52 comprises a laser diode, optics 55 preferably comprises a combination of one or more lenses, which are implemented by methods known in the art to collimate the generally diverging beam which radiates from the diode. Most preferably, the collimated beam has a divergence in an approximate range of 0.5-2.5 mrad. In preferred embodiments of the present invention, the beam is transmitted as a free-space beam via a path 57 to BTS-TC 27A, in which case the power emitted from optics 55 is most preferably less than a power level which causes deleterious effects when incident on a person.

The radiation from emitter 52 is received by an opto-electric transducer 80 in BTS-TC 27A, which converts the radiation into electrical signals, thus recovering the up-link RF signals output from amplifier 48. Transducer 80 comprises any transducer known in the art, such as a PIN diode, which is able to recover the modulation imposed on the optical radiation emitted by emitter 52. The pre-amplified signals from transducer 80 are conveyed via an isolating BPF 84 and an amplifier 86 to BTS-CCC 25A.

BTS-CCC 25A also supplies down-link RF signals to mobile 47, via a path 101, preferably in a frequency band 869-894 MHz, although any other suitable frequency band available in the communication protocol implemented in network 30 may be used. The signals transfer to a variable attenuator 96, which sets a level of the signals so as to provide a suitable modulation depth for an optical emitter 100. Emitter 100 is preferably substantially similar in operation and implementation to emitter 52, providing an electromagnetic wave output which is modulated by one of the methods described above with respect to emitter 52.

In some preferred embodiments of the present invention, attenuator 96 comprises an analog-to-digital converter (ADC) 97 which digitizes the down-link RF signals. Most preferably, the digitized RF signals are compressed by a method known in the art in attenuator 96 before being used to modulate emitter 100.

Radiation from emitter 100 is collimated by collimating optics 102. Optics 102 are generally similar to optics 55, and are implemented, depending on emitter 100, so as to generate a beam having a divergence in an approximate range of 0.5-2.5 mrad. The radiation from emitter 100 is transmitted via a free-space path 59, and is received by an opto-electric transducer 104 in AA-TC 29A, which converts the radiation into electrical signals, thus recovering the down-link RF signals output from attenuator 96. Transducer 104 is preferably substantially similar in operation and implementation to transducer 80, providing a pre-amplification stage for the recovered signals.

If a process of ADC has been implemented prior to modulating emitter 100, a corresponding digital-to-analog converter (DAC) 105 is implemented in transducer 104. Similarly, if attenuator 96 applies digital compression to the digitized signal, transducer 104 is implemented to apply a corresponding process of decompression known in the art so as to recover the down-link RF signal. It will be understood that a similar process of ADC then DAC, and/or digital compression and decompression, may be applied to the up-link RF signals. The scope of the present invention includes such processes of ADC then DAC, and digital compression and decompression, as applied to transmission of signals between an antenna assembly and its associated BTS.

The recovered pre-amplified signals are transferred to a power amplifier (PA) 106 which increases the power level to a suitable final output level, and the amplified signals from PA 106 are transferred to duplexer 41. Duplexer 41 transfers the amplified signals to antenna 31A, which radiates the signals as down-link RF signals to mobile 47.

It will be appreciated that while the description hereinabove has assumed that link 34A between antenna assembly 26A and its associated BTS 24A is generally via unguided optical radiation, the link may comprise other forms of unguided electromagnetic radiation, such as microwave radiation. Thus, the scope of the present invention includes links comprising unguided electromagnetic beams other than optical beams.

It will further be appreciated that radio-frequency signals which are transmitted in preferred embodiments of the present invention may comprise a plurality of RF signals. For example, diversity RF signals may be transmitted in addition to the up-link and/or the downlink RF signals, between antenna 31A and BTS-CCC 25A, using a multiplexing method known in the art. Thus, the scope of the present invention includes transmitting a plurality of RF signals substantially simultaneously.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for transferring information within a cellular network, comprising:
a base-station transceiver system (BTS) positioned at a first location, which comprises:
communication control circuitry, adapted to generate down-link radio-frequency (RF) signals receivable by a mobile cellular transceiver operative within the cellular network and to process up-link RF signals transmitted by the mobile cellular transceiver; and
first transducer circuitry, adapted to modulate a first beam of unguided electromagnetic radiation with the down-link RF signals and to radiate the modulated beam as a first modulated beam, and to receive and demodulate a second modulated beam of unguided electromagnetic radiation so as to recover the up-link RF signals; and
an antenna assembly, positioned at a second location remote from the first location, which comprises:
second transducer circuitry, adapted to modulate a second beam of unguided electromagnetic radiation with the up-link RF signals and to radiate the modulated beam as the second modulated beam to the BTS, and to receive and demodulate the first modulated beam of unguided electromagnetic radiation from the BTS so as to recover the down-link RF signals; and
an antenna, adapted to radiate the recovered down-link RF signals to the mobile cellular transceiver and to receive the up-link RF signals from the mobile cellular transceiver.

2. Apparatus according to claim 1, wherein the first and the second transducer circuitry are adapted to radiate the first modulated beam and the second modulated beam via a path between the BTS and the antenna comprising free space.

3. Apparatus according to claim 1, wherein at least one of the first and second transducer circuitry comprises a laser which transmits coherent radiation as the unguided electromagnetic radiation between the BTS and the antenna.

4. Apparatus according to claim 1, wherein at least one of the first and second transducer circuitry comprises at least one emitter which transmits incoherent radiation as the unguided electromagnetic radiation between the BTS and the antenna.

5. Apparatus according to claim 1, wherein the first location is separated from the second location by a distance chosen from a range between approximately 10 m and approximately 700 m.

6. Apparatus according to claim 1, wherein at least one of the first and second beams comprises electromagnetic radiation having a wavelength chosen from a range between approximately 0.3 μm and approximately 30 μm.

7. Apparatus according to claim 1, wherein at least one of the first and second beams comprises electromagnetic radiation having a wavelength chosen from a range between approximately 1 mm and approximately 30 cm.

8. Apparatus according to claim 1, and comprising a switching center which is adapted to generate the information responsive to the up-link and down-link signals and to transfer the information between the BTS and at least one communication system chosen from a group comprising a public switched telephone network (PSTN), a distributed packet transfer network, a satellite communications system, and a second cellular network.

9. Apparatus according to claim 1, and comprising a base-station controller (BSC) which controls the BTS.

10. Apparatus according to claim 1, wherein at least one of the down-link RF signals and the up-link RF signals comprise a plurality of separate RF signals.

11. Apparatus according to claim 1, wherein the first transducer circuitry comprises an analog-to-digital converter which is adapted to digitize the down-link RF signals so as to generate down-link digitized signals, and wherein the second transducer circuitry comprises a digital-to-analog converter which is adapted to recover the down-link RF signals from the down-link digitized signals.

12. Apparatus according to claim 11, wherein the first transducer circuitry is adapted to compress the down-link digitized signals so as to generate compressed down-link digital signals, and wherein the second transducer circuitry is adapted to decompress the compressed down-link digital signals so as to recover the down-link digitized signals.

13. Apparatus according to claim 1, wherein the second transducer circuitry comprises an analog-to-digital converter which is adapted to digitize the up-link RF signals so as to generate up-link digitized signals, and wherein the first transducer circuitry comprises a digital-to-analog converter which is adapted to recover the up-link RF signals from the up-link digitized signals.

14. Apparatus according to claim 13, wherein the second transducer circuitry is adapted to compress the up-link digitized signals so as to generate compressed up-link digital signals, and wherein the second transducer circuitry is adapted to decompress the compressed up-link digital signals so as to recover the up-link digitized signals.

15. A method for transferring information within a cellular network, comprising:
positioning a base-station transceiver system (BTS) at a first location;
generating in communication control circuitry comprised in the BTS down-link radio-frequency (RF) signals receivable by a mobile cellular transceiver operative within the cellular network;
modulating a first beam of unguided electromagnetic radiation with the down-link RF signals in first transducer circuitry comprised in the BTS, so as to form a first modulated beam;
radiating the first modulated beam from the first transducer circuitry;
receiving and demodulating a second modulated beam of unguided electromagnetic radiation in the first transducer circuitry so as to recover up-link RF signals transmitted by the mobile cellular transceiver;
processing the up-link RF signals in the communication control circuitry;
positioning an antenna assembly at a second location remote from the first location;
receiving in an antenna comprised in the antenna assembly the up-link signals from the mobile cellular transceiver;
modulating a second beam of unguided electromagnetic radiation with the up-link RF signals in second transducer circuitry comprised in the antenna assembly, so as to form the second modulated beam ;
radiating the second modulated beam from the second transducer circuitry to the BTS;
receiving and demodulating in the second transducer circuitry the first modulated beam from the first transducer circuitry so as to recover the down-link RF signals; and
radiating the recovered down-link RF signals from the antenna to the mobile cellular transceiver.

16. A method according to claim 15, wherein radiating the first modulated beam and radiating the second modulated beam comprises radiating the beams via a path between the BTS and the antenna comprising free space.

17. A method according to claim 15, and comprising providing at least one laser which transmits coherent radiation as the unguided electromagnetic radiation between the BTS and the antenna.

18. A method according to claim 15, and comprising providing at least one emitter which transmits incoherent radiation as the unguided electromagnetic radiation between the BTS and the antenna.

19. A method according to claim 15, wherein the first location is separated from the second location by a distance chosen from a range between approximately 10 m and approximately 700 m.

20. A method according to claim 15, wherein at least one of the first and second beams comprises electromagnetic radiation having a wavelength chosen from a range between approximately 0.3 μm and approximately 30 μm.

21. A method according to claim 15, wherein at least one of the first and second beams comprises electromagnetic radiation having a wavelength chosen from a range between approximately 1 mm and approximately 30 cm.

22. A method according to claim 15, and comprising a generating the information responsive to the up-link and down-link signals and transferring the information between the BTS and at least one communication system chosen from a group comprising a public switched telephone network (PSTN), a distributed packet transfer network, a satellite communications system, and a second cellular network.

23. A method according to claim 15, and comprising controlling the BTS with a base-station controller (BSC).

24. A method according to claim 15, wherein at least one of the down-link RF signals and the up-link RF signals comprise a plurality of separate RF signals.

25. A method according to claim 15, and comprising:
digitizing the down-link RF signals in an analog-to-digital converter comprised in the first transducer circuitry so as to generate down-link digitized signals, and
recovering the down-link RF signals from the down-link digitized signals in a digital-to-analog converter comprised in the second transducer circuitry.

26. A method according to claim 25, and comprising:
compressing the down-link digitized signals in the first transducer circuitry so as to generate compressed down-link digital signals; and
decompressing the compressed down-link digital signals in the second transducer circuitry so as to recover the down-link digitized signals.

27. A method according to claim 15, and comprising:
digitizing the up-link RF signals in an analog-to-digital converter comprised in the second transducer circuitry so as to generate up-link digitized signals, and
recovering the up-link RF signals from the up-link digitized signals in a digital-to-analog converter comprised in the first transducer circuitry.

28. A method according to claim 27, and comprising:
compressing the up-link digitized signals in the second transducer circuitry so as to generate compressed up-link digital signals; and
decompressing the compressed up-link digital signals in the first transducer circuitry so as to recover the up-link digitized signals.
